(19) United States
(12) Patent Application Publication
(10) Pub. No.: US 2024/0291077 A1
(43) Pub. Date: Aug. 29, 2024

(54) ELECTROLYTE FOR METAL-AIR BATTERY, PREPARATION METHOD THEREFOR, AND METAL-AIR BATTERY USING SAME

(71) Applicant: GACHON UNIVERSITY OF INDUSTRY-ACADEMIC COOPERATION FOUNDATION, Seongnam-si, Gyeonggi-do (KR)

(72) Inventors: Tae Young KIM, Hanam-si, Gyeonggi-do (KR); Kumud Malika TRIPATHI, Seongnam-si, Gyeonggi-do (KR); Gouri Sankar DAS, Seongnam-si, Gyeonggi-do (KR)

(21) Appl. No.: 18/568,979

(22) PCT Filed: Jun. 11, 2021
(86) PCT No.: PCT/KR2021/007360

§ 371 Date: Dec. 11, 2023

(51) Int. Cl. H01M 12/06; C01B 32/184

(52) U.S. Cl. CPC H01M 12/06; C01B 32/184; C01P 2002/82; C01P 2004/01; C01P 2006/40; H01M 2300/0014

(57) ABSTRACT

Disclosed is an electrolyte for a metal-air battery, comprising graphene nanoflakes so as to be capable of self-charging, and enabling a metal-air battery to exhibit excellent stability in a long-term charge/discharge cycle. The electrolyte for a metal-air battery, according to the present invention, comprises an alkaline solution and graphene nanoflakes dispersed in the alkaline solution, wherein the graphene nanoflakes can be surface-modified with a hydrophilic group.

### TECHNICAL FIELD

The present disclosure relates to an electrolyte for a metal-air battery including graphene nanoflakes and a method for preparing the same.

### DESCRIPTION OF RELATED ART

A metal-air battery is a battery that uses a metal such as iron, zinc, magnesium, and aluminum as a negative electrode (anode), and uses oxygen in the air as a positive electrode (cathode), and is composed of a positive electrode, a negative electrode, and an electrolyte.

During discharge, metal ions are generated while the metal is oxidized in the negative electrode, and the generated metal ions migrate through the electrolyte to the oxygen air electrode as the positive electrode. In the positive electrode, external oxygen is dissolved in the electrolyte through the positive electrode and is reduced. For example, an zinc-air battery enables the generation of electricity based on a following reaction at the negative and positive electrodes during discharging.

Positive electrode: 2Zn+4OH⁻→2ZnO+2H₂O+4e⁻

Negative electrode: O₂+2H₂O+4e⁻→4OH⁻

As described above, the metal-air battery generates electricity by collecting electrons generated by reacting oxygen in the air and metal with each other in the electrolyte. The metal-air battery generates a current while electrons generated in the negative electrode migrate to the positive electrode along an external conductive line.

Since the metal-air battery uses oxygen which may be supplied without limitation from the air, as a positive electrode active material, the metal-air battery has an energy density significantly higher than an energy density of the lithium ion battery limited by the theoretical capacity of each of the positive electrode material and the negative electrode material.

In addition, since the negative electrode material of the metal-air battery is relatively safe and inexpensive, the metal-air battery is safe and economical. Therefore, the metal-air battery is suitable for high capacity required in transportation equipment such as electric energy storage and automobiles, and is economical and environmentally friendly.

However, even though the metal-air battery has a high energy density, there is a disadvantage in that the metal-air battery has difficulty in exhibiting substantially fully the theoretical energy density, has a short lifespan, and generates an overvoltage due to high polarization. In a representative example, the metal-air battery generates a metal oxide when being discharged. The metal oxide has a low ion conductivity. Thus, when the metal oxide covers the positive electrode, the polarization is increased such that energy efficiency of the battery is reduced. In addition, when the metal-air battery is discharged, an oxygen reduction reaction (ORR) occurs in the positive electrode. When the metal-air battery is charged, an oxygen evolution reaction (OER) may occur in the positive electrode. In particular, since the oxidation-reduction reaction of the oxygen gas exhibits a very slow reaction rate, charging and discharging may not be smoothly performed, and charging/discharging cycle life may be deteriorated.

Therefore, the metal-air battery uses a catalyst for promoting the oxygen reduction reaction (ORR) and the oxygen evolution reaction (OER). The catalyst generally includes a noble metal catalyst such as platinum (Pt) or a metal oxide such as IrO₂, RuO₂ or the like. However, this catalyst is very expensive. Because this catalyst is a solid-phase catalyst, the catalyst activity is low, or efficiency is low. Recently, research has been conducted to include a soluble catalyst in the electrolyte. In this approach, the catalyst efficiency may be increased because the catalyst can freely move inside the electrolyte. However, when the oxidized soluble catalyst moves to the negative electrode and reacts therewith to generate a side reactant, such that the charge/discharge capacity and lifespan of the battery are also deteriorated.

Therefore, in order to improve the capacity and lifespan of the metal-air battery, it is still required to develop a novel electrolyte having high catalytic reaction efficiency and high stability.
(Patent Document 1) Korean Patent No. 10-1851564 (25 Apr. 2018)

### DISCLOSURE

### Technical Purpose

It is a purpose of the present disclosure to provide an electrolyte which includes a surface-functionalized graphene nanoflake and thus has excellent charging/discharging efficiency and may exhibit excellent stability of a metal-air battery in a long-term charging/discharging cycle.

It is a purpose of the present disclosure to provide an electrolyte capable of increasing the efficiency of an oxygen evolution reaction in a positive electrode of a metal-air battery to allow the battery to be self-charged.

It is a purpose of the present disclosure to provide a metal-air battery using the electrolyte.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

### Technical Solution

An electrolyte for a metal-air battery according to the present disclosure comprises: an alkaline solution; and graphene nanoflakes dispersed in the alkaline solution, wherein the graphene nanoflake is surface-modified with a hydrophilic group.

A method for preparing an electrolyte for a metal-air battery according to the present disclosure comprises: (a) hydrothermal-treating a carbon-containing precursor; (b) carbonizing the hydrothermal-treated carbon-containing precursor to prepare graphene nanoflakes; and (c) treating the graphene nanoflakes with an acid solution such that a surface thereof is modified with a hydrophilic group; and (d) dispersing and mixing the surface-modified graphene nanoflakes in and with an alkaline solution.

A metal-air battery according to the present disclosure comprises: a negative electrode including a metal; a positive electrode including oxygen as an active material; and an electrolyte interposed between the negative electrode and the positive electrode, wherein the electrolyte comprises an alkaline solution and graphene nanoflakes dispersed in the alkaline solution, and each of the graphene nanoflakes is surface-modified with a hydrophilic group.

### Technical Solution

The electrolyte according to the present disclosure is applied to the metal-air battery, and thus contains the graphene nanoflakes. Thus, the metal-air battery including the electrolyte can be self-charged, may have high charge/discharge efficiency, and may exhibit excellent charge/discharge cycle life.

In addition, the process for preparing the electrolyte according to the present disclosure is simple, and the metal-air battery using the electrolyte according to the present disclosure exhibits remarkably high charge and discharge efficiency and charge/discharge cycle life compared to conventional metal-air batteries.

In addition to the above-described effects, specific effects of the present disclosure will be described with reference to the detailed description of the present disclosure.

### BRIEF DESCRIPTION OF THE DRAWINGS

FIG. 1 is a process diagram showing a method for preparing an electrolyte for a metal-air battery according to the present disclosure.

FIGS. 2 and 3 illustrate characteristics of a surface-modified graphene nanoflake included in an electrolyte for a metal-air battery according to the present disclosure.

FIG. 4 is a view illustrating a configuration of a metal-air battery according to the present disclosure and a state in which the metal-air battery is connected to an external circuit.

FIGS. 5 and 6 are views illustrating characteristics of a metal-air battery according to the present disclosure.

FIG. 7 illustrates self-charging characteristics of a metal-air battery according to the present disclosure.

FIG. 8 shows a self-charging mechanism of a metal-air battery according to the present disclosure.

### DETAILED DESCRIPTIONS

The above-described purposes, features, and advantages will be described in detail with reference to the accompanying drawings, and thus a person skilled in the art could easily implement the technical spirit of the present disclosure. In the following description of the present disclosure, a detailed description of known technologies related to the present disclosure will be omitted when it may make the gist of the present disclosure rather unclear. Hereinafter, preferred embodiments of the present disclosure will be described in detail with reference to the accompanying drawings. In the drawings, like reference numerals refer to like or similar elements.

It will also be understood that when a first element or layer is referred to as being present “on” a second element or layer, the first element may be disposed directly on the second element or may be disposed indirectly on the second element with a third element or layer being disposed between the first and second elements or layers. It will also be understood that when a first element or layer is referred to as being present “under” a second element or layer, the first element may be disposed directly under the second element or may be disposed indirectly under the second element with a third element or layer being disposed between the first and second elements or layers.

It will be understood that when an element or layer is referred to as being “connected to”, or “coupled to” another element or layer, it may be directly connected to or coupled to another element or layer, or one or more intervening elements or layers therebetween may be present. In addition, it will also be understood that when an element or layer is referred to as being “between” two elements or layers, it may be the only element or layer between the two elements or layers, or one or more intervening elements or layers therebetween may also be present.

Hereinafter, an electrolyte for a metal-air battery, a preparing method thereof, and a metal-air battery using the same according to an embodiment of the present disclosure will be described.

In accordance with the present disclosure, a metal-air battery refers to a secondary battery in which a metal such as zinc, lithium, magnesium, aluminum, or the like is combined with oxygen in the air to generate electricity. The metal-air battery includes a negative electrode including a metal, a positive electrode including oxygen as an active material, and an electrolyte interposed between the negative electrode and the positive electrode.

First, an electrolyte that may be applied to the metal-air battery and a method of preparing the same will be described.

The term “air” as used herein is not limited to atmospheric air, and may include a combination of gases including oxygen, or pure oxygen gas.

### Electrolyte for Metal-Air Battery

The electrolyte for the metal-air battery of the present disclosure includes surface-functionalized graphene nanoflakes.

The electrolyte for the metal-air battery is a space in which an electrochemical reaction of an electrode occurs and ions migrates. The electrolyte for the metal-air battery may be obtained by dissolving a metal salt in water as an aqueous electrolyte. For example, in the lithium-air battery, the electrolyte may be an aqueous solution of lithium salt. In addition, in the zinc-air battery, the electrolyte may be an alkaline aqueous solution. The alkaline aqueous solution may be a potassium hydroxide (KOH) aqueous solution, but is not particularly limited thereto. In some cases, the alkaline aqueous solution may be an aqueous solution of sodium hydroxide (NaOH), an aqueous solution of ammonium hydroxide (NH₄OH), and the like. The alkaline aqueous solution may prevent a deficiency of hydroxide ions (OH⁻) in the negative electrode, thereby improving the output characteristics and discharge efficiency of the metal-air battery. The alkaline solution used as the electrolyte of the present disclosure may serve as a buffer capable of maintaining the concentration of hydroxide ions (OH⁻) in the negative electrode, and may reduce electric resistance to improve the performance of the metal-air battery.

To this end, the electrolyte for the metal-air battery preferably includes an alkaline solution. The alkaline solution may include, for example, at least one of potassium hydroxide (KOH), sodium hydroxide (NaOH), and ammonium hydroxide (NH₄OH). The concentration of the alkaline solution may be approximately 1 to 10 M, preferably 2 to 6 M. When the concentration of the alkaline solution is lower than 1 M, it may not be sufficient to prevent a deficiency of hydroxide ions in the negative electrode. On the contrary, when the concentration of the alkaline solution exceeds 10 M, the effect resulting from increasing the electrolyte ion concentration may be insignificant.

More specifically, the alkaline solution has a metal salt dissolved in the solution, and the metal salt may include the same metal as the metal used for the negative electrode. For example, zinc acetate may be used as the metal salt included in the electrolyte in the zinc-air battery. The concentration of the metal salt may be in a range of about 0.01 M to about 1 M, for example, about 0.01 M to about 0.5 M. When the concentration of the metal salt deviates from a range of about 0.01 M to about 1 M, the concentration balance of the metal ions may be lost to deteriorate charge and discharge cycle characteristics.

The surface-functionalized nanoflake refers to carbon having a two-dimensional structure including a graphene crystal structure and including a functional group including oxygen, nitrogen, sulfur, phosphorus, and the like on a surface thereof. The surface-functionalized graphene nanoflake serves as a catalyst that is oxidized or reduced during charging and discharging to allow an oxygen reduction reaction (ORR) or an oxygen evolution reaction (OER) to be performed well in the positive electrode of the metal-air battery.

The surface-functionalized graphene nanoflakes may be included in an electrolyte and may act as a redox mediator to promote the ORR or OER reaction in the positive electrode. Accordingly, the surface-functionalized graphene nanoflakes serve to allow the battery to be smoothly charged and discharged, and improve capacity efficiency of the metal-air battery.

In addition, the graphene nanoflakes included in the electrolyte have high catalytic reaction efficiency due to high specific surface area, thereby leading to improved performance of the battery.

The surface-functionalized graphene nanoflake used in the present disclosure refers to the two-dimensional structure carbon including a graphene crystal structure, and including a functional group including oxygen on a surface thereof.

A plurality of graphene nanoflakes are dispersed in the alkaline solution. When the size of the graphene nanoflake of the present disclosure is several tens of μm or larger, graphene may be precipitated in the electrolyte solution, and thus a partial short circuit may occur.

Therefore, the graphene nanoflake may have a size of about 1 nm to about 10 μm. The size of the graphene nanoflake may be a length in a longitudinal direction of a long axis, or a length in the longitudinal direction or a length in the transverse direction. The graphene nanoflake may be made of reduced or oxidized graphene, and may be compose of a single layer or multiple layers.

It is preferable that the graphene nanoflake may be surface-modified with a hydrophilic group in order to improve properties of graphene. The surface modified graphene nanoflakes may prevent precipitation, agglomeration, or suspension in the electrolyte and provide improved dispersibility. The hydrophilic group may include at least one of a hydroxyl group, a carboxyl group, a carbonyl group, an amino group, and a phosphoric acid group.

The surface-modified graphene nanoflakes may be present in an amount of about 5 wt % to about 50 wt % based on 100 wt % of the alkaline solution. When the surface-modified graphene nanoflakes are present in an amount smaller than 5 wt %, the charge/discharge cycle lifetime improvement effect is reduced.

Conversely, when the surface-modified graphene nanoflakes is present in an amount greater than 50 wt %, graphene may be precipitated in the alkaline aqueous solution.

### Method for Preparing Electrolyte for Metal-Air Battery

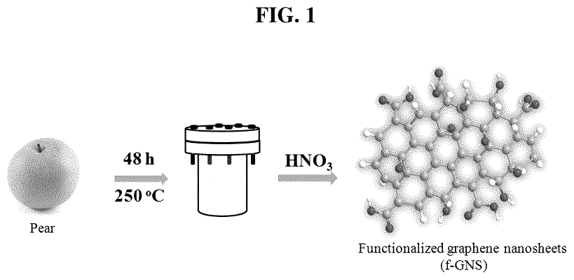

FIG. 1 is a process diagram showing a method for preparing an electrolyte for a metal-air battery according to the present disclosure.

First, a carbon-containing precursor is subjected to hydrothermal treatment.

The carbon-containing precursor as a carbon source may be hydrothermal-treated at 180 to 250° C. for 12 to 48 hours.

The hydrothermal-treated carbon-containing precursor may be purified with an organic solvent such as acetone, methanol, or the like using a Soxhlet extractor.

The carbon-containing precursor may include a plant-derived organic material, a polymer compound, pitch, fruit, starch, or the like. The plant-derived organic material may include an organic material derived from coffee beans. The polymer compound may include a thermosetting resin such as a phenol resin. The pitch may be a petroleum-based or coal-based pitch. The fruit may include pear, apple, and the like.

Subsequently, the hydrothermal-treated carbon-containing precursor is carbonized to prepare the graphene nanoflakes.

The carbonization may be performed at a temperature of about 300° C. to about 1000° C. When the carbonization temperature is lower than 300° C., the carbonization is not sufficiently performed, and thus carbon crystals including graphene may not be produced well. On the contrary, when the carbonization temperature exceeds 1000° C., the yield of the finally obtained graphene nanoflakes may be deteriorated.

A carbonization time may be in a range of 1 to 10 hours. However, an embodiment of the present disclosure is not limited thereto.

Then, in order to functionalize the prepared graphene nanoflakes, the graphene nanoflakes are treated with an acid solution such that the surface of the graphene nanoflakes is modified with a hydrophilic group.

A mixing ratio as a weight ratio of the graphene nanoflake:the acid solution may be in a range of 1:1 to 1:10. However, an embodiment of the present disclosure is not limited thereto. In this step, it is important to stir the mixture of the graphene nanoflakes and the acid solution such that the graphene nanoflakes are sufficiently mixed with the acid solution. The acid solution may be nitric acid, sulfuric acid, hydrochloric acid, or the like.

After the surface modification has been performed using the acid solution, the acid solution is dried and removed. Thus, the graphene nanoflake surface-modified with the hydrophilic group may be obtained. In this regard, the hydrophilic group may include at least one of a hydroxyl group, a carboxyl group, a carbonyl group, an amino group, and a phosphoric acid group.

Subsequently, the surface-modified graphene nanoflakes are dispersed and mixed in and with the alkaline solution to prepare an electrolyte.

In this step, stirring may be performed at 25±10° C., and the surface-modified graphene nanoflakes are uniformly dispersed in the alkaline solution.

### Metal-Air Battery

The electrolyte prepared according to the preparation method of the present disclosure may be applied to a metal-air battery. The metal-air battery includes a negative electrode including a metal, a positive electrode including oxygen as an active material, and an electrolyte interposed between the negative electrode and the positive electrode. One surface of the negative electrode and one surface of the positive electrode are in contact with the electrolyte.

The electrolyte includes the alkaline solution and the graphene nanoflakes dispersed in the alkaline solution. Each of the graphene nanoflakes is surface-modified with the hydrophilic group.

The negative electrode may be embodied as a metal plate or an alloy plate, and may be replaced when metal is consumed. The metal included in the negative electrode may include at least one of zinc, lithium, magnesium, and aluminum.

The positive electrode may be a plate-shaped electrode having a relatively smaller thickness than that of the negative electrode, and may be manufactured by adding a positive electrode material to a binder solution to prepare a slurry, and then applying the slurry to a current collector.

A conductive material may be used in the positive electrode using the oxygen as an active material. The conductive material may be used without limitation as long as it has porosity and conductivity. For example, the conductive material may include a porous carbon-based material. As such a carbon-based material, carbon black, graphite, graphene, activated carbon, carbon fiber, and the like may be used alone or in combination with each other.

An operation of the metal-air battery of the present disclosure is as follows. The metal-air battery generates electricity based on a following reaction.

Positive electrode 2Zn+4OH⁻→2ZnO+2H₂O+4e⁻ (1)

Negative electrode: O₂+2H₂O+4e⁻→4 OH⁻ (2)

During the discharge (1) to (2), the metal is oxidized in the negative electrode to generate electrons. In the positive electrode, the oxygen meets with electrons migrating from the negative electrode, such that an oxygen reduction reaction (ORR) may occur.

During the discharge, the graphene nanoflakes of the present disclosure are included in an electrolyte and serves as a catalyst for promoting the oxygen reduction reaction in the positive electrode. This reaction formula (3) to (7) is as follows.

O₂+*→O₂* (3)

O₂*+H₂O(l)+e⁻→OOH*+OH⁻ (4)

OOH*+e⁻→O*+OH⁻ (5)

O*+H₂O (l)+e⁻→OH*+OH⁻ (6)

OH*+e⁻→*+OH⁻ (7)
where * represents an active site of the surface of the graphene nanoflake, and O*, OH*, and OH** represent an intermediate product of the surface of the graphene.

During the charging (8) to (9), an inverse reaction to the reactions (1) to (2) during the discharging occurs.

Negative electrode 2 ZnO+2 H₂O 4 e⁻→2 Zn+4 OH⁻ (8)

Positive electrode: 4 OH⁻→O₂+4 OH⁻ (2)

During charging (8) to (9), an oxygen evolution reaction in which oxygen is produced may occur in the positive electrode. During charging, the graphene nanoflake of the present disclosure serves as a catalyst for promoting an oxygen evolution reaction in the positive electrode.

This reaction formula (10) to (14) is as follows.

OH⁻+*→OH*+e⁻ (10)

OH*+OH⁻→O*→H₂O (l)+e⁻ (11)

0*+OH⁻→OOH*+e⁻ (12)

OOH*+OH⁻→*+O₂ (g)+H₂O (l)+e⁻ (13)
where * represents an active site of the surface of the graphene nanoflake, and O*, OH*, and OH** represent an intermediate product of the surface of the graphene.

As described above, the metal-air battery according to the present disclosure may include the electrolyte containing the surface-modified graphene nanoflakes, and thus be self-charged, and may exhibit excellent stability of the metal-air battery in a long-term charging/discharging cycle.

In addition, the electrolyte according to the present disclosure has a simple preparing process. The metal-air battery using the electrolyte of the present disclosure may generate electricity in a short time without using a catalyst.

The metal-air battery according to the present disclosure may be a secondary battery that may be charged and discharged, and may be used as a power source of an electric vehicle, a hybrid electric vehicle, or a power source of a power storage device. In addition, the metal-air battery according to the present disclosure may generate energy at low cost, and may be manufactured without limitation in shape and size, and thus may be used without limitation in space.

The electrolyte for the metal-air battery, the method for preparing the same, and the metal-air battery using the same are described below based on specific examples thereof.

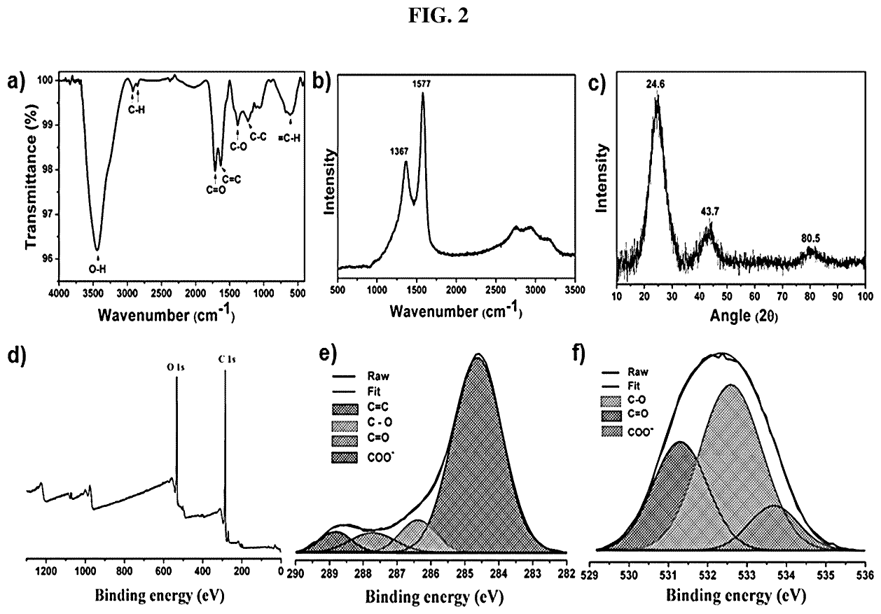

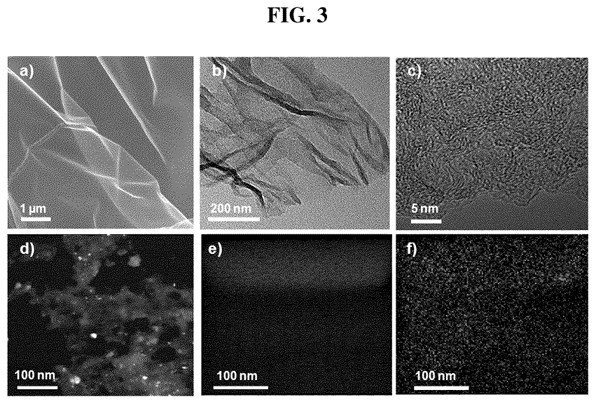

FIGS. 2 and 3 illustrate characteristics of a surface-modified graphene nanoflake included in an electrolyte for a metal-air battery according to the present disclosure. The surface-modified graphene nanoflakes measured in FIGS. 2 and 3 are prepared by a following method.

First, the pear using a carbon source was subjected to hydrothermal treatment at 250° C. for 48 hours. The hydrothermal-treated carbon source was subjected to purification using a Soxhlet extractor and with acetone and then was subjected to carbonization at 400° C. for 2 hours. Thus, the graphene nanoflakes were prepared. Subsequently, the prepared graphene nanoflakes were mixed with nitric acid (HNO₃), and then the remaining nitric acid solution was removed from the mixture to prepare the surface-modified graphene nanoflake.

In FIG. 2, (a) is a result of FTIR measurement showing the presence of an oxygen functional group on the graphene skeleton. In FIG. 2, (b) is as a result of Raman measurement showing graphene properties. In FIG. 2, (c) is a result of XRD measurement showing the phase purity of a synthetic material. In FIG. 2, (d) is a result of XPS measurement showing a composition and a surface function. In FIG. 2, (e) and (f) are a result of XPS measurement showing that a functional group including oxygen is formed on the surface of the graphene nanoflake.

In FIG. 3, (a) is a SEM image showing that the surface-modified graphene nanoflake has a sheet shape. In FIG. 3, (b) is a TEM image showing a multilayer graphene nanoflake sheet randomly oriented, in which wrinkles are observed. The wrinkles are non-repetitive and irregular. In FIG. 3, (c) is an HRTEM image showing a lattice stripe. In FIG. 3, (d) to (f) are a result of element mapping measurement showing a uniform distribution of carbon and oxygen.

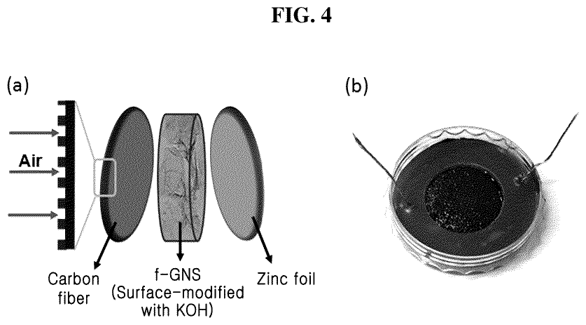

FIG. 4 is a view illustrating a configuration of a metal-air battery according to the present disclosure and a state in which the metal-air battery is connected to an external circuit.

In FIG. 4, (a) is an exploded perspective view of a metal-air battery including a carbon fiber thin plate steel (a strip, a diameter of 0.05 mm) as a positive electrode, a zinc foil as a negative electrode, and an electrolyte in which the surface-modified graphene nanoflakes are dispersed in a 6M ammonium hydroxide (KOH) containing 0.2 M zinc acetate (Zn(CH₃CO₂)₂). In FIG. 4, (b) is a view illustrating a state in which the metal-air battery of (a) in FIG. 4 is connected to an external circuit.

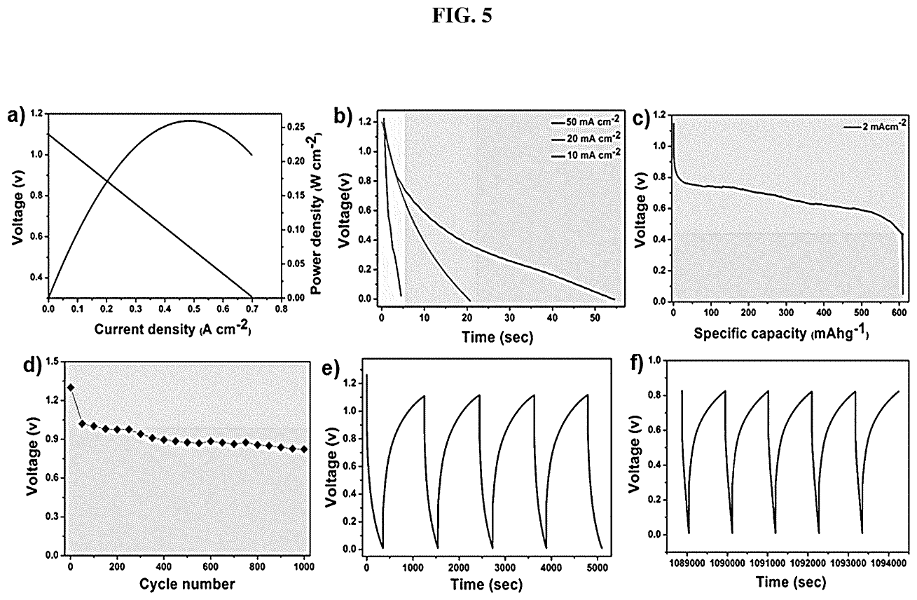

FIGS. 5 to 7 illustrate characteristics of the zinc-air battery manufactured in FIG. 4.

In FIG. 5, (a) shows a polarization curve and a power profile of the zinc air battery. In FIG. 5, (b) shows a discharge profile of the zinc air battery based on a varying current density. In FIG. 5, (c) is a typical proportional capacity (specific capacity) curve. In FIG. 5, (d) shows the long-term stability experiment result of self-charging at a discharge and self-charging mode (at 15 minutes stop) up to 1000 cycles at a current density of 5 mAcm⁻². In FIG. 5, (e) shows a constant current discharge and self-charging curve for first four cycles. In FIG. 5, (f) shows a constant current discharge and self-charging curve for last four cycles.

Referring to (e) and (f) in FIG. 5, it may be confirmed that the zinc air battery is self-charged for a long period of time.

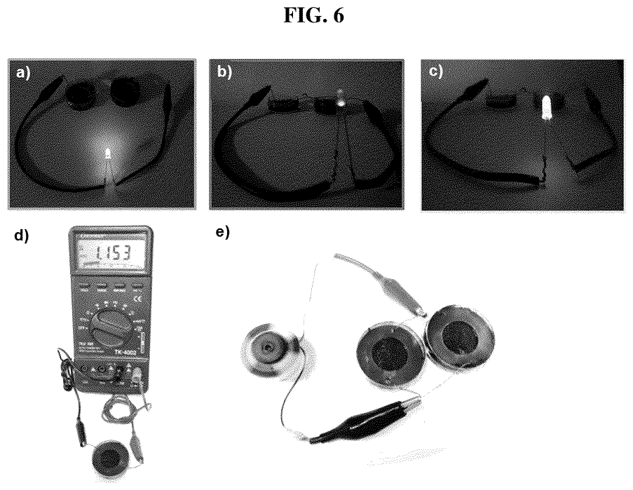

FIG. 6 shows performance of a zinc air battery, and shows various colors and brightness.

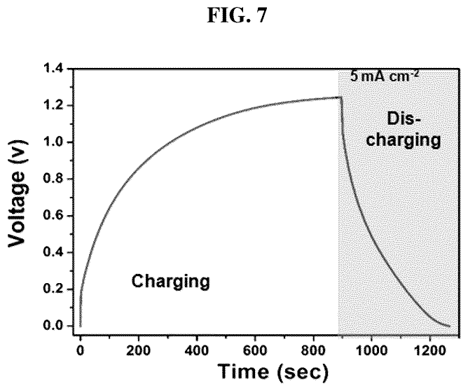

FIG. 7 shows a self-charging process in air and a constant current discharge process at a current density of 5 mAcm⁻². The bright yellow region (left) indicates that the battery is self-charged due to breathing of the surface-modified graphene nanoflake (f-GNS) in the air.

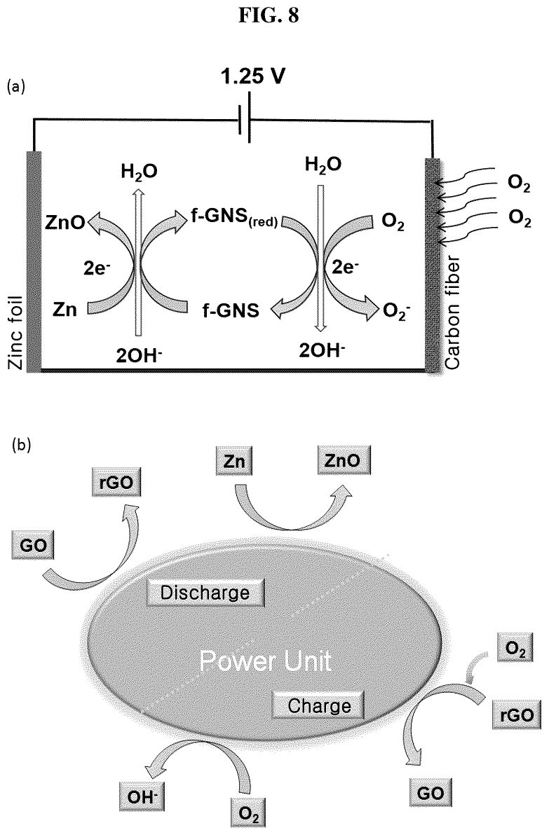

FIG. 8 shows a self-charging mechanism of a metal-air battery according to the present disclosure.

The surface-modified graphene nanoflakes (f-GNS) included in the electrolyte serve as a catalyst that promotes an oxygen reduction reaction in the positive electrode during discharge, and serves as a catalyst that promotes an oxygen evolution reaction in the positive electrode during charging.

Although the present disclosure has been described with reference to the drawings, the present disclosure is not limited by the embodiments disclosed in the present specification and the drawings, and various modifications may be made by a person skilled in the art within the scope of the present disclosure. In addition, it should be appreciated that although the effect according to the configuration of the present disclosure is not explicitly described while the embodiment of the present disclosure is described above, the effect that could be predicted by the corresponding configuration should also be recognized.

What is claimed is:

1. An electrolyte for a metal-air battery, comprising:
an alkaline solution; and
graphene nanoflakes dispersed in the alkaline solution, wherein the graphene nanoflake is surface-modified with a hydrophilic group.

2. The electrolyte for the metal-air battery of claim 1, wherein the hydrophilic group includes at least one of a hydroxyl group, a carboxyl group, a carbonyl group, an amino group, and a phosphoric acid group.

3. A method for preparing an electrolyte for a metal-air battery, the method comprising:
(a) hydrothermal-treating a carbon-containing precursor;
(b) carbonizing the hydrothermal-treated carbon-containing precursor to prepare graphene nanoflakes; and
(c) treating the graphene nanoflakes with an acid solution such that a surface thereof is modified with a hydrophilic group; and
(d) dispersing and mixing the surface-modified graphene nanoflake in and with an alkaline solution.

4. The method of claim 3, wherein the (a) is performed at a temperature of about 180° C. to about 250° C.

5. The method of claim 3, wherein the (b) is performed at a temperature of about 300° C. to about 1000° C.

6. The method of claim 3, wherein in the (c), the hydrophilic group includes at least one of a hydroxyl group, a carboxyl group, a carbonyl group, an amino group, and a phosphoric acid group.

7. A metal-air battery comprising:
a negative electrode including a metal;
a positive electrode using oxygen as an active material; and
an electrolyte interposed between the negative electrode and the positive electrode,
wherein the electrolyte includes an alkaline solution and graphene nanoflakes dispersed in the alkaline solution,
wherein each of the graphene nanoflakes is surface-modified with a hydrophilic group.

8. The metal-air battery of claim 7, wherein the negative electrode includes at least one of zinc, lithium, magnesium, and aluminum.
